(19) United States
(12) Patent Application Publication
(10) Pub. No.: US 2006/0033377 A1
(43) Pub. Date: Feb. 16, 2006

(54) Laterally moving, sectional, material-dumping, vehicle bed conversion unit

(76) Inventor: Dale Martin Frimel, N. Royalton, OH (US)

Correspondence Address: DALE FRIMEL, 12742 DRAKE RD., NORTH ROYALTON, OH, 44133, US

(21) Appl. No.: 10/917,809

(22) Filed: Aug. 13, 2004

(51) Int. Cl. B62D 33/00

(52) U.S. Cl. 298/1 A

(57) ABSTRACT

A sectional, free-floating floor which can slide upon rails, where such floor sections can be pulled via a cable by a motorized cable puller, such as a winch or similar manually operated pulling machine. The invention can be placed without fasteners within a loading vehicle such as a pickup truck, and any material can be loaded upon the floor sections described. The cable puller can be energized in a direction such as to pull the floor section furthest from the vehicle bed end and push each of the adjacent unattached floor sections along with it. This pulling continues and each of the floor sections are pushed, one after another, until each of the floor sections fall off of the end of the bed of a loading vehicle, dumping any material that is on each floor section off of the vehicle. The invention can also be used in military supply trucks.

### CROSS REFERENCE TO RELATED APPLICATIONS

| | | |
|---|---|---|
| U.S. PAT. NO. 6,749,267 | June, 2004 | Brooks |
| U.S. PAT. NO. 5,447,361 | September, 1995 | Phillips |
| U.S. PAT. NO. 6,196,634 | March, 2001 | Jurinek |
| U.S. PAT. NO. 5,310,119 | May, 2002 | Feller |
| U.S. PAT. NO. 5,772,389 | June, 1998 | Feller |

### STATEMENT REGARDING FEDERALLY SPONSORED RESEARCH OR DEVELOPEMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

1. Field of the Invention

The field of the invention would relate in general to unloading or dumping devices, and specifically to dumping conversion units associated with vehicles designed to unload material or supplies such as those used in the military, construction, or building industries. The present invention relates to a machine that can rest within the space of a flat bed pickup truck, van, or pull trailor bed, which will unload material or supplies (which was loaded upon it) by moving the material laterally along the length of and off of said vehicle without the use of an expensive lift system, or conveyer belt. The problems with present art in this area are the following.
a) Material-dumping methods now involve the lifting of a bed which allows the loaded material to slide off of the bed. This method is limited/restricted by over-head obstructions such as high voltage electrical wires, tree branches, etc. The lifting of the bed requires great height clearances which are not always possible or convenient, and sometimes dangerous. Reference U.S. Pat. No. 6,196,634.
b) The bed-lifting dump method is also an expensive vehicle conversion since the lifting of great amounts of weight requires heavy and expensive parts such as hydraulic units, and heavy shafts and bearings. The replacement or repair of such parts is expensive, and not affordable for small construction and landscaping companies. Reference U.S. Pat. No. 6,196,634, and U.S. Pat. No. 6,749,267, and U.S. Pat. No. 5,310,119.
c) The amount of time needed to convert a standard vehicle to a bed-lifting one and then back again, is large. Lost time equates to lost money in any business. In regards to the military, time is an essential factor in maintaining the safety of personnel. Reference U.S. Pat. No. 6,196,634.
d) The use of the present day art of an endless conveyer is also expensive and involves the use of a large number of wearable and expensive parts such as wheels and bearings. Reference U.S. Pat. No. 6,557944, and U.S. Pat. No. 6,354,786.
e) The use of an endless conveyer system is also heavy, and combersome to utilize. In regards to the military, the ability to carry light conversion kits which will convert standard supply trucks into quick-umloading supply trucks can improve greatly the efficiency of military, supply delivering objectives.

2. Brief Description of the Invention

A structure having a number of rails close in length to the beds of existing vehicles used to haul loads of supplies or material. A floor made of a number of sections, are positioned to fit together so that they can slide on top of, and along the length of rails, which run along the bed length of the vehicle. A motorized unit having the ability to pull heavy loads with a line or cord, is attached to one end of the framed structure in such a way as to have the ability to pull the end sectional floor laterally along the length of the vehicle bed so that the loaded sections are pushed off of the bed of the vehicle, along with the material, or supplies loaded upon these sections. Because the pulling force is directed along the direction of the rails, and because the frame sections are positioned against each other, no fasteners are required for assembly.

### BRIEF SUMMARY OF THE INVENTION

The present invention was developed to allow a standard vehicle, made to haul objects or material (such as a supply truck, a van, or a pulled trailor) to be converted to a vehicle which can automatically dump its load out of the back of said vehicle, inexpensivly and easily.

This invention can be easily assembled onto an existing vehicle bed, and removed just as easily, using lightweight parts (unlike lift or coveyer systems).

The use of this invention eliminates the cause for concern where overhead obstacles are present (unlike the bed-lift systems).

This invention is inexpensive, and yet strong enough to move large amounts of loaded material. The entire invention requires only one inexpensive winch, one very inexpnsive pulley, and very little framing and flooring materials. The cost estimate for this invention is one tenth the cost of the present art of a lifting type conversion system, and one tenth the cost of an endless conveyer type conversion system. A small company can convert standard pick-up trucks to dump trucks and back again rather than purchase a separate dump vehicle, without investing much money.

The military can convert existing supply trucks quickly, and easily into supply trucks which could unload an entire load of supplies in only a few minutes by one operator.

The entire vehicle conversion from a standard vehicle, to a material-dumping vehicle (with this invention) takes less than ten minutes. The conversion back to a standard vehicle takes less than ten minutes as well. This all makes for an affordable, and practical invention which the military, many small and large businesses can find use for

Another advantage is that when the invention is assembled on the vehicle bed, there are no permanent fasteners needed. All the frame units fit in guides located on each frame piece so that all the frame pieces are centered. When the motorized cable puller is energized, all of the force from the cable tension is directed in such a way as to compress the frame along the axis of the rail supports, thus tending to hold the frame together. Thus, no permanent fasteners are needed to preserve the shape of the framed structure. This makes the dump conversion a quick and easy process.

### BRIEF DESCRIPTION OF THE SEVERAL VIEWS OF THE DRAWINGS

FIG. 1 shows the theory of operation.

FIG. 1-1 shows a common or standard winch. This is a well known device which acts as a motorized cable puller, and is used to slowly pull loads more then six thousand pounds along a lateral motion.

FIG. 1-2 is a cable made of a strong material such as nylon, or steel.

FIG. 1-3 is a common pulley used for changing the force direction of a cable, and is made of a material of sufficient strength to withstand the same force as the winch can withstand.

FIG. 1-4 is a smaller-width section of floor used as the pull section of flooring. The material can be of wood, or metal, or fiberglass, or plastic which can withstand the weight of about two hundred pounds per square foot without significant deformation. A typical ratio of width to length would be roughly one to four.

FIG. 1-5 are floor sections, as in FIG. 1-4 except the width to length ratios can be closer to one to two. These floor sections are used as the free-motion sections of flooring.

FIG. 1-7 shows a fastener which is securely attached to the pusher-floor section, FIG. 1-4. This fastener has a looped section to allow the cable, FIG. 1-2, to be attached to it.

FIG. 1-8 is the common control switch which will allow the winch, FIG. 1-1, to be turned on and off.

FIG. 2 shows the basic framing of the invention. All of the framing can be made such that each frame section merely rests within an adjacent section by the use of notches, or attached guides. These guides can allow the frame sections to be put together quickly while maintaining proper frame alignment. The guides can be nothing more than slightly notched-out sections within each frame part, and are not shown for clarity.

FIG. 2-9 is the pulley-end section of framing—although the pulley assembly, FIG. 1-3, is not shown here for clarity.

FIG. 2-10 shows the winch-end section of framing. This is shown here without the winch for clarity.

FIG. 2-12 are the frame rail-support sections. They support the rails, FIG. 2-13, which are attached to the rail supports.

FIG. 2-11 are cross supports which are right angles to, and support the rail-support sections of framing. All of the framing is made of a strong material such as metal, or fiberglass, or plastic, or wood, which can support an approximate lateral strength of about about five hundred pounds per square foot. The rails can be made of a strong material such as metal, or fiberglass, or plastic, or wood, and can have a surface area that would be of a low friction type.

FIG. 3 shows a bottom view of the entire invention, minus the cross supports, FIG. 2-11. The cross supports are not shown for clarity. Also, the view does not show the rails, since they are attached to the opposite sides (top) of the rail supports, FIG. 3-12. FIG. 3 shows the rail supports, FIG. 3-12, the floor-pusher floor section, FIG. 3-4, the pulley-end support, FIG. 3-9, the winch-end support, FIG. 3-10, the winch, FIG. 3-1, the pulley, FIG. 3-3, the cable, FIG. 3-2, the free-moving main floor sections, FIG. 3-5, and the floor-pusher cable connection unit, FIG. 3-7. Note that the pulley, FIG. 3-3, is secured to the pulley-end frame section, FIG. 3-9. Also note that the winch, FIG. 3-1, rests within the winch-end section of the end frame, FIG. 3-10, in such a way as to allow the cable, FIG. 3-2, to go through an opening in the winch-end section, FIG. 3-10, so that the pulling of the cable will tend to compress the frame along the direction of the cable, and thus hold the frame securely together. Also note that the flooring merely rests upon the floor-supporting rails, and is not a secured part of the frame itself. Also note that it is common for a winch to have a hook on the end of it's pulling cable end. This hook is shown to hook in a loop which is on one end of the cable (FIG. 3-2). The other end of this cable is attached to the floor-pusher section of flooring, FIG. 3-4.

FIG. 4 shows the top view of the entire invention. We can only see the main floor sections, FIG. 4-5, the ends of the rail supports, FIG. 4-12, the pulley-end of the end support, FIG. 4-9, the floor-pusher floor section, FIG. 4-4, and the ends of the rails, FIG. 4-13 can be seen.

FIG. 5 shows a close-up view of the bottom of any of the floor sections. The view shows grooves that run in a direction along the axis of the cable (the cable can be seen in FIG. 1, and FIG. 3). The arrow shows the direcion in which the floor section would move.

FIG. 6 shows a view of the invention with a load of material, FIG. 6-14, on it. The cross-supports, FIG. 2-11, are not shown for claruty.

FIG. 7 shows a view of the invention while in the process of dumping the loaded material. Note that the floor section nearest the rail ends is unloading with the material. The rail supports, FIG. 7-12, the rails, FIG. 7-13, the floor-pusher floor section, FIG. 7-4, and the floor sections, FIG. 7-5 can also be seen.

FIG. 8 shows the entire invention resting withing the bed of a material handling vehicle. The arrow shows the direction in which the floor sections would move when the winch is energized.

FIG. 9 shows the smaller floor-pusher floor section, FIG. 9-4, and one of the larger, floating floor sections, FIG. 9-5. This view is the only view that shows how the floor sections may have an extended section on the top side of the floor section, which would overlap the adjacent floor section for the purpose of preventing any loaded material from falling on to the rails beneath the floor sections. The arrow shows how the floor sections would push against each other, forming a flat and continuous top floor surface.

FIG. 10 shows a variation of rail design. Here, the rail, FIG. 10-16, acts as a rail, and replaces the rail support. This design requires a tubular material strong enough to support the lateral compression force of the pulling cable, much as the rail supports in the previous design, and can be made of a strong material such as metal, or plastic. We see the pulley end of the frame, FIG. 10-9, the rail cross support, FIG. 10-11, and a floor section, FIG. 10-5. FIG. 11 shows a variation in floor section design.

FIG. 11 shows the bottom of a floor section having rows of wheels secured within a groove on the bottom of the floor section. The surface of the wheels extend beyond the bottom floor surface so they can ride within rail guides designed to accomodate the width of the rails.

FIG. 11-17 shows the wheels withing the floor section, FIG. 11-5.

FIG. 12 shows an end view (floor section moving towards the viewer) of a floor section using the wheel design. We can see the wheels, FIG. 12-17, the floor section, FIG. 12-5, the rail supports, FIG. 12-12, and rail guides, FIG. 12-19. The rail guides can be of a material made to handle the pressure and wear of the wheels. The wheel design can be used where much heavier loads are required.

### DETAILED DESCRIPTION OF THE INVENTION

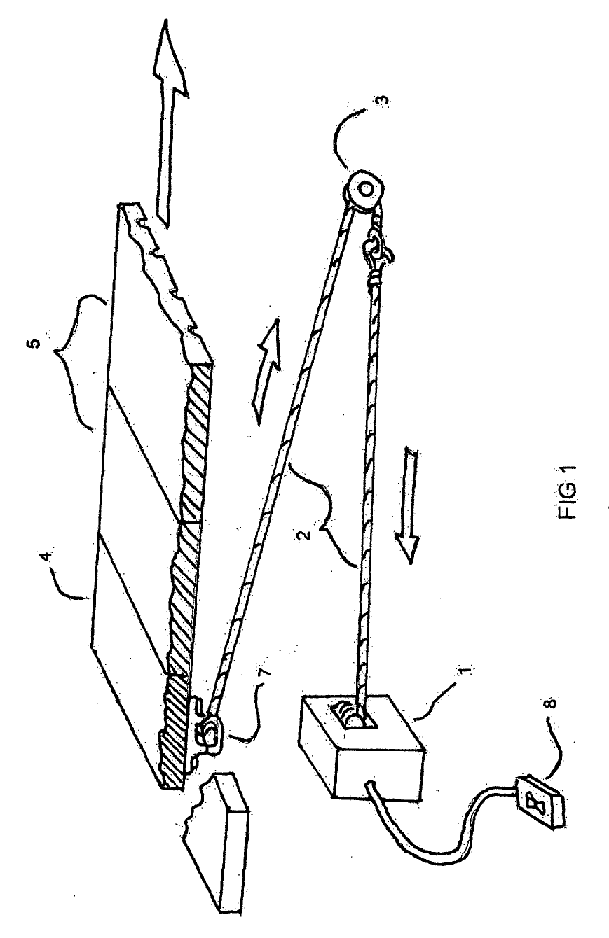

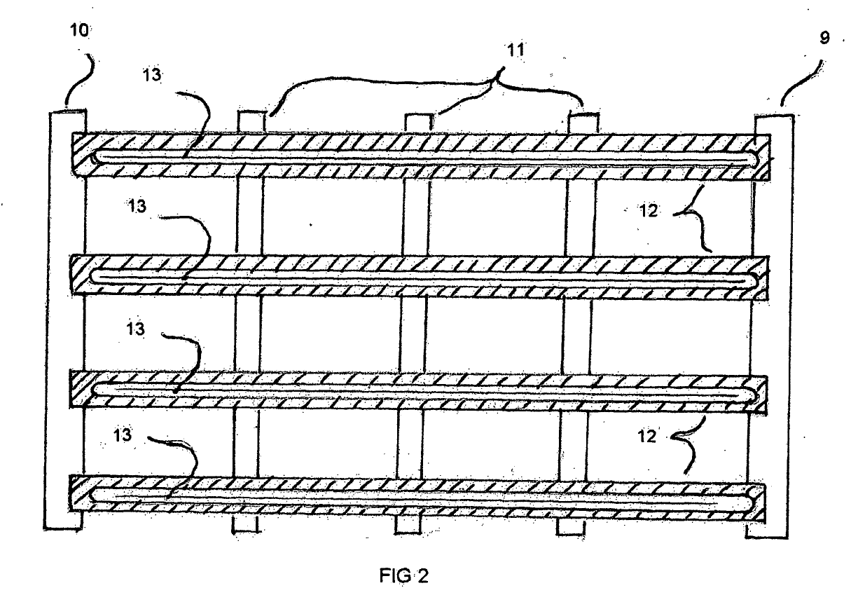

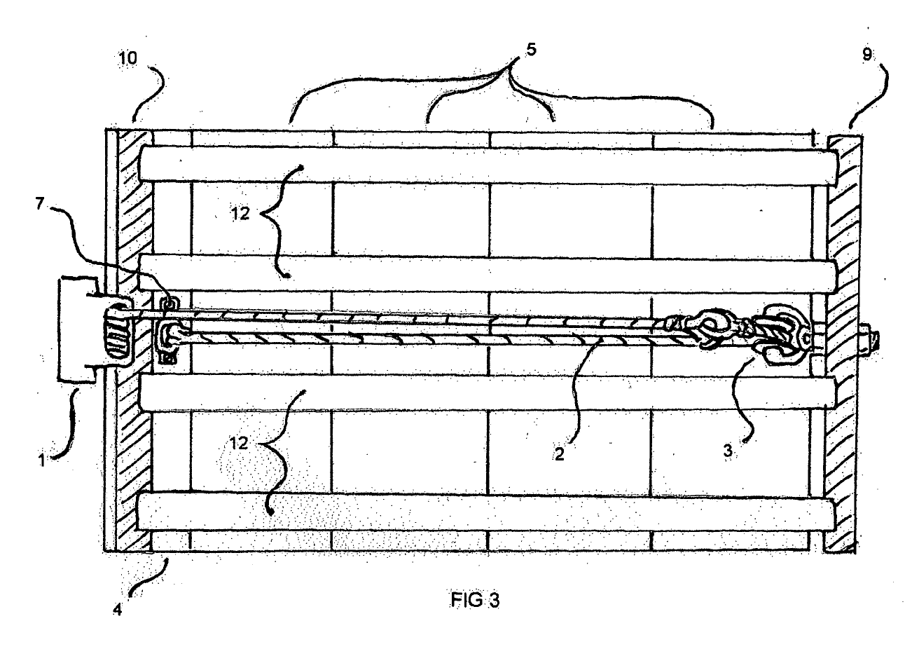

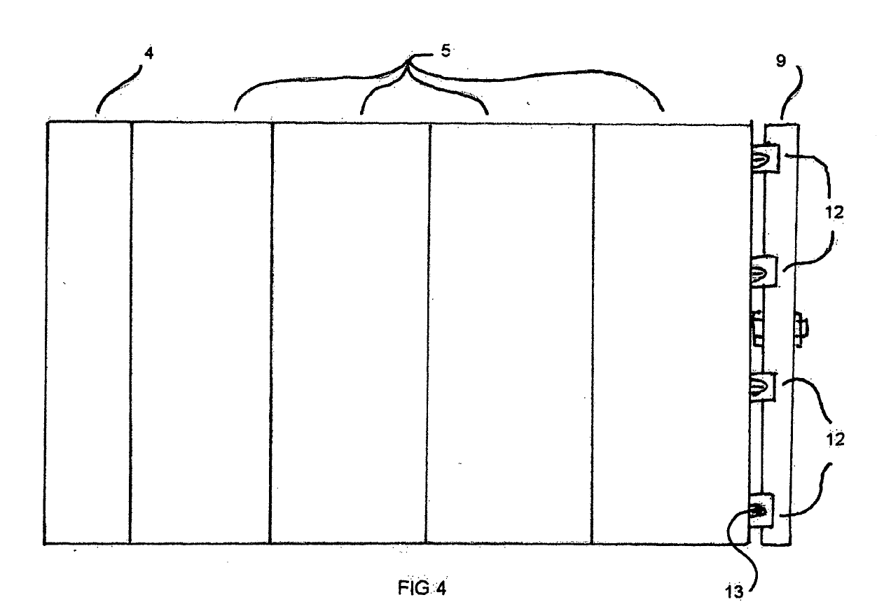

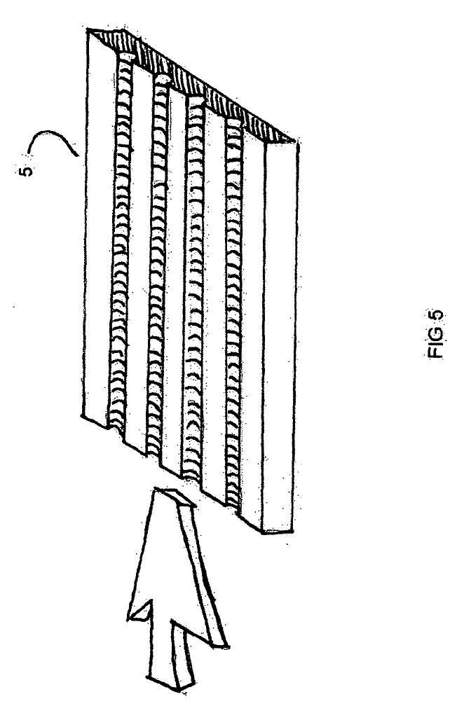

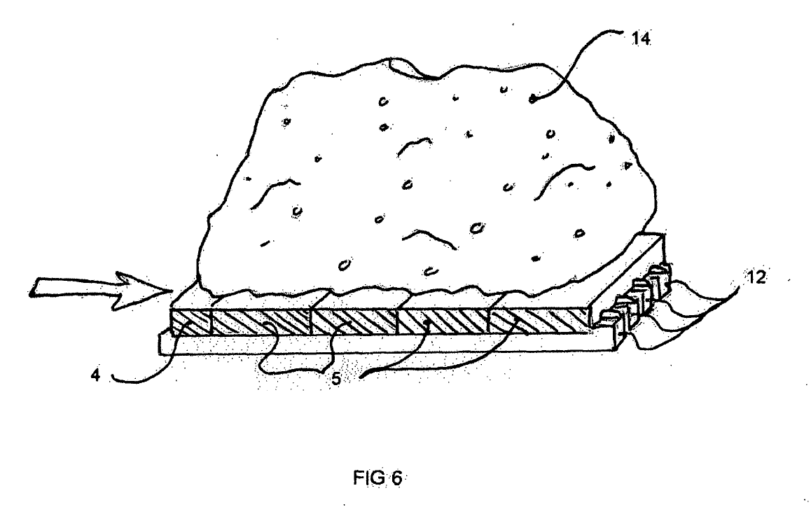

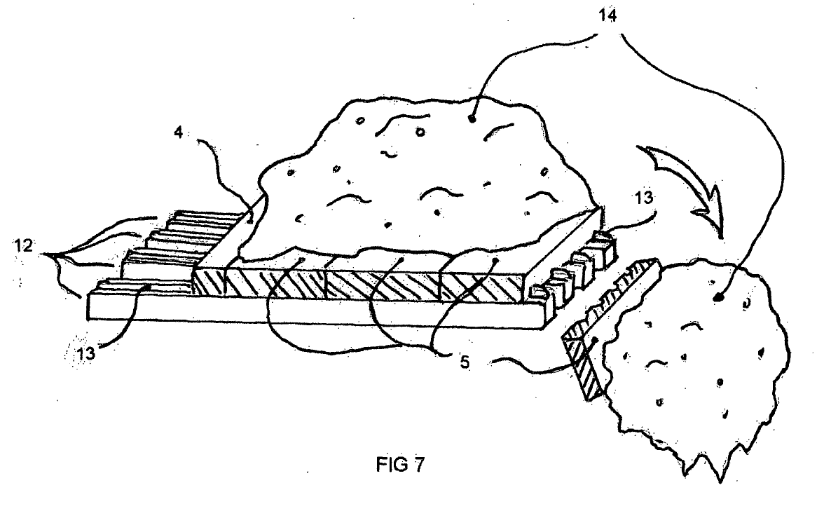

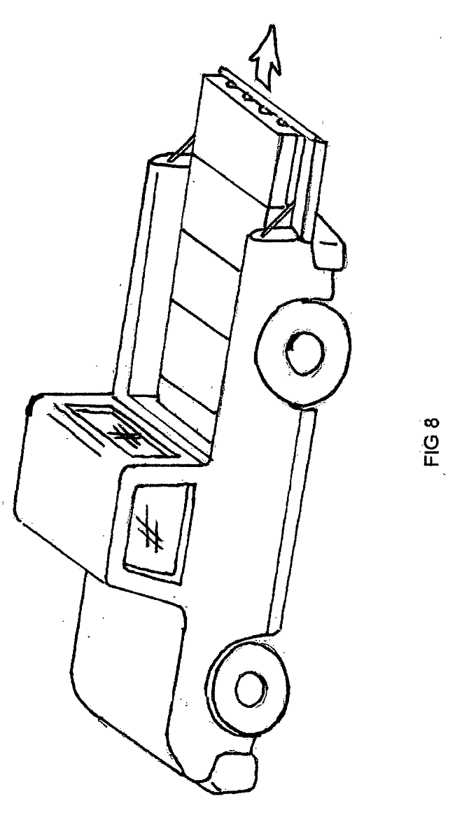

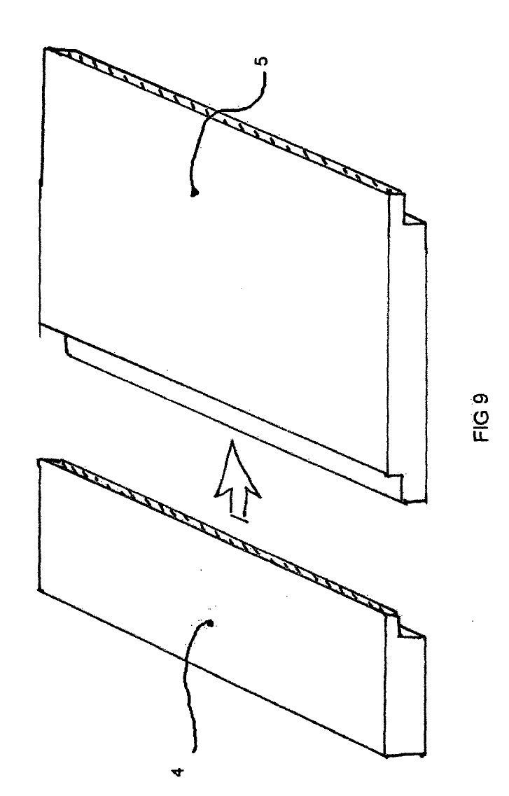

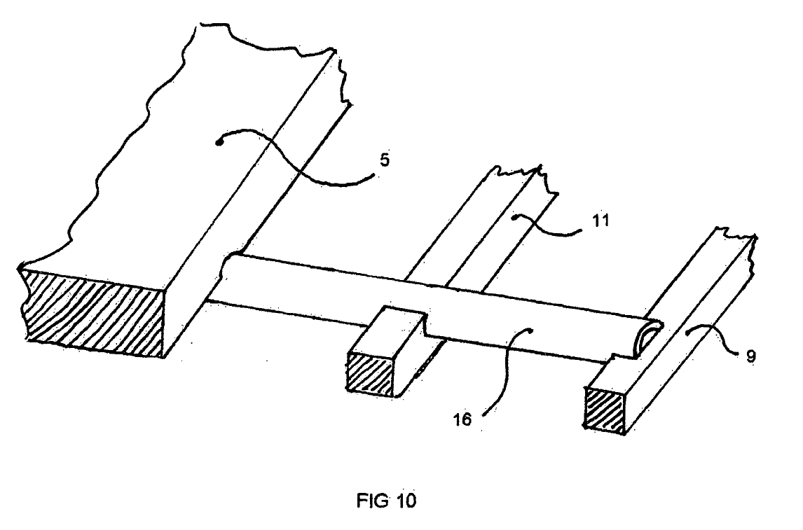

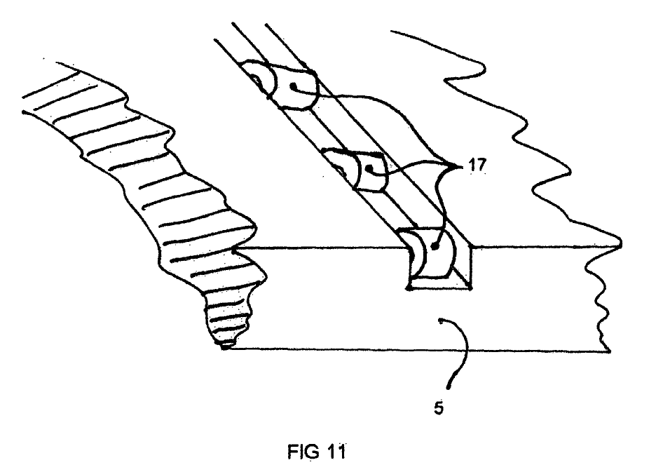

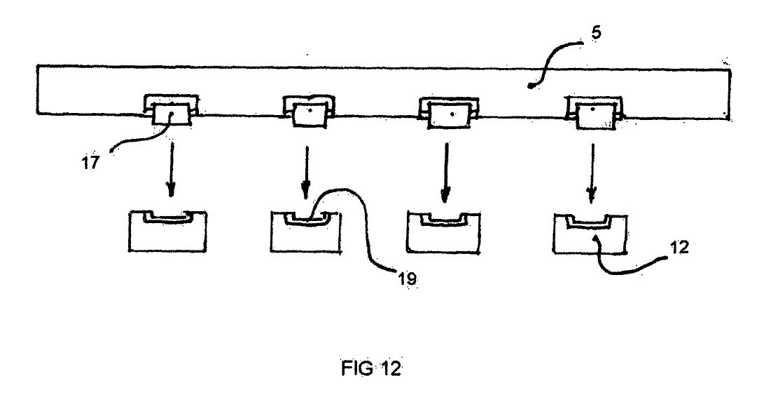

FIG. 2 shows the frame of the structure of the invention. In reference to FIG. 2, item 12 are the rail supports that fit into grooves, or guides within the end supports 9, and 10. Item 11 are cross supports that support the rail supports in a similar fashion of fit. Item 13 are the rails which are fixed to the rail supports with fasteners. The rail supports, and the rails can be considered one unit during assembly. FIG. 2 shows a number of rail supports which support a number of rails. FIG. 3-10 shows that on one side of the frame, we see the frame that supports a motorized, geared-down unit which pulls a cable which goes around a pulley on the opposite side. The cable continues back to the left side where it hooks on to the floor-pusher floor section FIG. 3-4. The floor sections are numerous sections of floor which are used to support material loaded upon it. These floor sections have rail guides (shown in FIG. 5) which ride on the rails. The floor sections can have an over-lapping top edge which covers a small portion of the floor section adjacent to it (FIG. 9). The purpose of the over-lap is to prevent the loaded material from spilling onto the rails. The purpose of the rail guides, or grooves within the floor sections, is to allow the floor sections to slide off of the rails without skewing off of the rails to one side or the other of the cable-pull motion. A lesser desired design would be the use of small wheels withing the grooves, or ball bearings within the grooves to allow a smoother, but more expensive design (FIG. 11, and FIG. 12). The pulley on the right side is supported by a frame also (FIG. 3-9). The rail supports themselves are supported by individual single frame units, FIG. 2-11, which are at right angles to, and beneath the rail supports. The number of frame units depends upon the weight of the load upon the floor sections. A rule of thumb is that there should be at least the same number of frame units as there are rail supports minus one. FIG. 2 shows four rail supports, and three centerd frame supports, as well as the end frame supports (shown at the left and at the right in FIG. 2). When this entire assembly is set upon the bed of an existing vehicle (with the back of the vehicle to the right in this example, as in FIG. 8), and material is loaded upon the floor sections (such as gravel, or dirt, or any other material or items of a weight permitted by the size of the vehicle), and the motor is energized, the cable is pulled along the lateral direction of the rails (see FIG. 1), around the pulley, and pulls the left-most floor section in the direction to the right. This floor section, pushes adjacent floor sections along the same direction until the right most section drops off of the vehicle bed, causing the material on it to drop as well (FIG. 6, and FIG. 7). The motor motion is controlled by a standard on and off control attached to the motorized cable puller. When the first floor section drops, the motor is stopped. At this time, the operator can remove the dropped floor section so it is not covered by any more material. The motor is started again until the next section drops material by also dropping off of the vehicle bed. This process continues until all of the material is dumped. When the dumping is complete, the floor sections are replaced (after cleaning any material from the rails, and the rail guides), and the vehicle is ready for another load. The motorized cable puller can be of any size or power type which can handle the force needed to pull the load required for any individual existing vehicle. The flooring material would be strong enough to support the load requirements of the loading vehicle that the invention is placed in. The cable, likewise, must be of a material of strength sufficient to support the load force produced by the vehicle load. In reference to the control circuit, a limit switch can be located in such a position under the floor sections, and fastened to the frame, for the purpose of electrically shutting off the current to the motor when the last floor section has reached the end of the vehicle bed, thus preventing the motor from pulling the pull cable further then the usable length of the vehicle bed. The function of an electrical limit switch is common, and well known in the electro-mechanical design of numerouse machines. The number of floor sections are determined by the amount of load that the vehicle (that carries the invention) is intended for, as well as how much material is needed to be dumped at each drop of a floor section. A good rule of thumb is there should be at least the same number of floor sections as number of rail supports.

What I claim as my invention is:

1. A truck dumping conversion unit comprising:
a motor pulled, moving sectional floor, whose individual floor sections are not attached to each other; and rides on rails, supported by a frame, and made for the purpose of resting within the bed of an existing hauling vehicle such as a pickup truck, a van, or a pulled hauling trailer such that; none of the invention parts need be attached to the dumping vehicle being converted; with floor sections that fall off of rails as the floor sections are pushed off by pulling one end floor section with a line or cable, which in turn pushes the other floor sections off the rails supporting them as well as any material which was loaded upon the floor sections.

2. The pulling of a floor section, with a fixture attached to a motorized or manual cable puller, by a line or cable via a pulley for the purpose of pushing, and sliding adjacent and unattached individual floor sections off of rails for the purpose of dumping, or unloading any material or supplies that is loaded upon the floor sections being pushed by such a floor section.

3-5. (canceled)
